(19) United States
(12) Patent Application Publication
(10) Pub. No.: US 2019/0331109 A1
(43) Pub. Date: Oct. 31, 2019

(54) Electrofluidic Assembly and Method for its Operation

(71) Applicant: Thomas Magnete GmbH, Herdorf (DE)

(72) Inventors: Axel Müller, Siegen (DE); Thomas Rolland, Gebhardshain (DE); Michael Müller, Hennef (DE); Thomas Baum, Hennef (DE); Edwin Kreuzberg, Daaden (DE); Johann Scheiermann, Niedernhall (DE)

(21) Appl. No.: 16/395,670

(22) Filed: Apr. 26, 2019

(30) Foreign Application Priority Data
Apr. 28, 2018 (DE) 10 2018 003 508.6

(51) Int. Cl. F04B 49/06; F04B 35/04; F04B 49/08; F04B 49/22; F04B 51/00; F16K 31/06

(52) U.S. Cl. CPC F04B 49/06; F04B 35/045; F04B 49/08; F04B 49/22; F04B 2205/02; F16K 31/0655; F04B 2205/16; F04B 2205/15; F04B 2205/10; F04B 51/00

(57) ABSTRACT

An electrofluidic assembly and method for its operation. The functions of a reciprocating pump and of a valve should be combined in one assembly. Here, in particular the pump and the valve should interact so that a small number of line connections are required. A pump assembly and a valve are arranged on an identical central line and use a bearing rod jointly for movable bearing of a first solenoid armature which activates a displacement apparatus of the pump assembly on one hand and a second solenoid armature of the valve which activates a group of closing bodies on the other hand. The electrofluidic assembly can be used for monitoring tank systems.

### CROSS-REFERENCE TO RELATED APPLICATIONS

This application claims the benefit and priority of German Application No. 10 2018 003 508.6 filed on Apr. 28, 2018. The entire disclosure of the above application is incorporated herein by reference.

### FIELD

The present disclosure relates to an electrofluidic assembly which comprises at least an electrofluidic pump assembly and an electrofluidic valve, as well as methods for operating the assembly.

### BACKGROUND

This section provides background information related to the present disclosure which is not necessarily prior art.

Reciprocating pumps are known, including those with a drive by means of an electromagnet. Valves which are actuated by an electromagnet are also known and widely available. Assemblies are furthermore known which comprise a pump and at least one valve. Such assemblies are, however, complex to produce.

### SUMMARY

This section provides a general summary of the disclosure, and is not a comprehensive disclosure of its full scope or all of its features.

An assembly should be described which combines the functions of a reciprocating pump and a valve and can be produced at low cost in high numbers. In this case, in particular the pump and the valve are supposed to interact such that a small number of line connections are required.

The electrofluidic assembly according to the disclosure contains at least one electrofluidic pump assembly and an electrofluidic valve. In this case, both the pump assembly and the valve are activated by in each case one electromagnet.

The pump assembly and the valve are arranged on an identical central line and use a bearing rod jointly for movable bearing of a first solenoid armature which activates a displacement apparatus of the pump assembly on one hand and of a second solenoid armature of the valve which activates a group of closing bodies on the other hand.

In a first embodiment, in the deenergized state of the associated electromagnet, the valve fluidically connects the inlet of the assembly to the outlet of the assembly while bypassing the pump assembly, wherein the stated connection is closed in the energized state of the electromagnet.

In a second embodiment, in the energized state of the associated electromagnet, the valve fluidically connects the inlet of the assembly to the outlet of the assembly while bypassing the pump assembly, wherein the stated connection is closed in the deenergized state of the electromagnet.

The pump assembly advantageously has a bellows which is directly or indirectly activated linearly by the first electromagnet and which acts as a fluidic displacement apparatus. In this case, a restoring spring acts counter to the force of the electromagnet, and in the case of a suitable frequency of the actuation pulses to the electromagnet the spring/mass system, which is composed of a restoring spring and the solenoid armature of the electromagnet, enters into resonance with the actuation impulses.

Alternatively to this, the pump assembly has a fluidic displacement apparatus which is composed at least of a cylinder and a piston.

The pump assembly further advantageously has an inlet valve which is composed of a valve seat and a valve body, wherein the valve body has a highly elastic disc and a centrally arranged holder.

The pump assembly likewise advantageously also has an outlet valve which is composed of a valve seat and a valve body, wherein the valve body has a highly elastic disc and a centrally arranged holder.

The arrangement of the inlet valve and of the outlet valve is based on whether the assembly is supposed to generate an overpressure or a vacuum in the connected line to a tank or to another apparatus. The electrofluidic assembly is suitable for both objects, with it being necessary for the stated valves to be installed in the suitable orientation for this purpose.

The electrofluidic assembly advantageously contains a pressure sensor which is connected to the outlet of the assembly.

The electrofluidic assembly likewise advantageously contains a temperature sensor which is connected to the outlet of the assembly.

For operation of the electrofluidic assembly according to the disclosure, an electric control unit connected to the electrofluidic assembly actuates the electromagnets in such a manner that
a fluidic pressure difference is built up at the outlet in that, in the case of closed valve, the electromagnet of the pump assembly is energized in a clocked manner, wherein the solenoid armature correspondingly moves the displacement apparatus and wherein fluid is conveyed and in this case the gas pressure in a connected tank is increased or reduced,
the clocked energization of the electromagnet of the pump assembly is terminated and the valve is held closed by an energization of its electromagnet,
a pressure profile in a connected tank is measured in that a pressure sensor connected to the outlet or to the supply line to the tank transmits the profile of the pressure in the tank to the electric control unit, wherein the profile of the pressure is recorded in the electric control unit,
after a defined time Tv, measurement and recording of a second pressure profile are carried out, wherein duration in time Tv is based on the size of the connected tank,
the two pressure profiles are compared with one another and the imperviousness of the tank is concluded from the difference between the two pressure profiles,
the pressure in the tank (32) is reduced, the valve (3) is opened in that the associated electromagnet (4) is deenergized.

The method for operating the electrofluidic assembly can be improved in that, during each measurement and recording of the pressure in the tank, the temperature of the fluid at the outlet or in the supply line to the tank is also measured and recorded by a temperature sensor, wherein then the temperature profiles are also used with the aid of the ideal gas law to calculate a corrected profile of the pressure profiles during comparison of the pressure profiles.

The method for operating an electrofluidic assembly can be further improved in the sense of OBD (On-Board Diagnosis) in that the electric control unit monitors the electrofluidic assembly in terms of its proper function, wherein both the profile of the energization of the electromagnet of the pump assembly and the profile of the pressure measured by the pressure sensor are recorded by the electric control unit and, by a comparison of the stated profiles including setpoint profiles stored in table form, malfunctions of the pump assembly or of the valve are discovered and reported to at least one superordinate electric control unit.

After a start of operation of the electrofluidic assembly at a temperature below a defined threshold temperature TG, the electric control unit (33) actuates at least one of the electromagnets (4, 4′) with electric pulses of a frequency greater than a defined threshold frequency fG until the temperature measured with the temperature sensor (31) in the assembly exceeds threshold temperature TG.

As a result of the high-frequency actuation of at least one electromagnet, no noticeable movements of the valve and/or the pump are generated, but the relevant magnetic coil heats up and discharges heat to the working fluid. Threshold temperature TG is based on the working fluid and threshold frequency fG lies significantly (more than 30%) above the resonance frequency of the spring/mass system which is composed of a solenoid armature and an associated restoring spring.

Assemblies of the described type are used to monitor tank systems, but can also be used where a reciprocating pump and a valve should be used jointly at low pressure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a section through an exemplary assembly in the embodiment with a bellows in the pump assembly and with a valve which closes in the energized state.

FIG. 2 shows a schematic representation of the assembly in the embodiment with a cylinder in the pump assembly.

FIG. 3 shows a section through an exemplary pump assembly in detail.

Corresponding reference numerals indicate corresponding parts throughout the several views of the drawings.

### DETAILED DESCRIPTION

Example embodiments will now be described more fully with reference to the accompanying drawings.

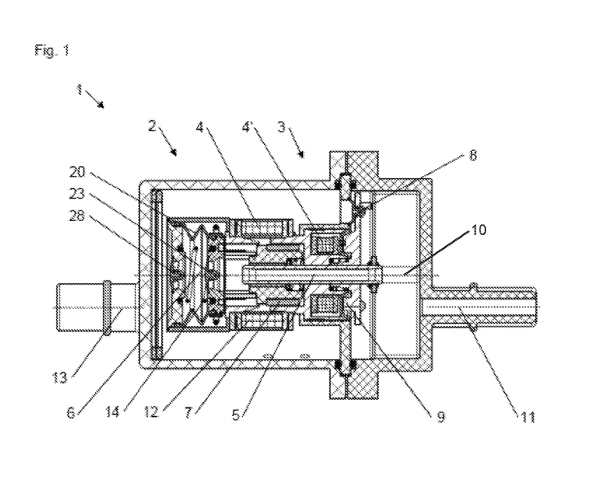

The exemplary embodiment of the electrofluidic assembly (1) according to FIG. 1 contains an electrofluidic pump assembly (2) and an electrofluidic valve (3), wherein both the pump assembly (2) and the valve (3) are activated by in each case one electromagnet (4, 4′).

The pump assembly (2) and the valve (3) are arranged on an identical central line (10) and use a bearing rod (5) jointly for movable bearing of a first solenoid armature (7) which activates a displacement apparatus (6) of the pump assembly (2) on one hand and a second solenoid armature (9) of the valve (3) which activates a group of closing bodies (8) on the other hand.

The bearing rod (5) is formed as a tube which fluidically connects the displacement apparatus (6) of the pump assembly (2) to the inlet (11) of the assembly (1).

The possible alternative arrangement, is the case of which the tube connects the displacement apparatus to the outlet.

In the deenergized state of the electromagnet (4′) which activates the valve (3), the valve (3) fluidically connects the inlet (11) of the assembly (1) to the outlet (13) of the assembly (1) while bypassing the pump assembly (2), wherein the stated connection is closed in the energized state of the electromagnet (4′).

The possible alternative arrangement, in the case of which, in the energized state of the electromagnet (4′) which activates the valve (3), the valve (3) fluidically connects the inlet (11) of the assembly (1) to the outlet (13) of the assembly (1) while bypassing the pump assembly (2).

The pump assembly (2) represented in FIG. 1 has a bellows (20) which is activated linearly by the electromagnet (4) and which acts as a fluidic displacement apparatus (6).

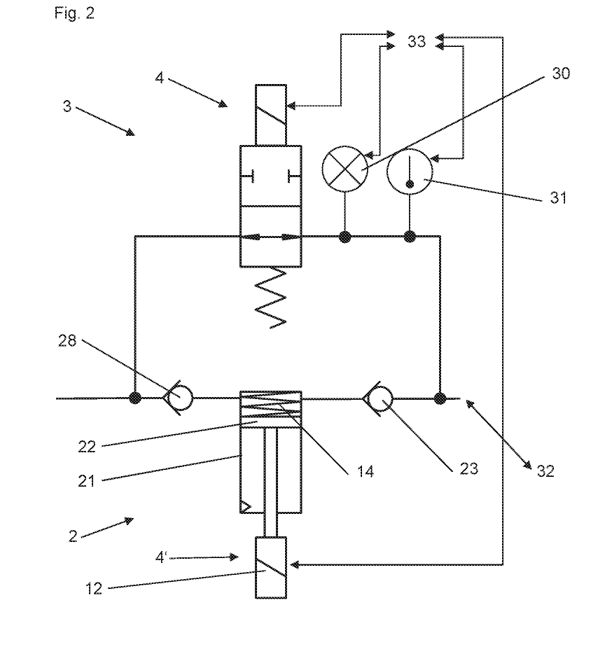

The possible alternative fitting of the pump assembly (2) with a cylinder (21) and a piston (22) is represented schematically in FIG. 2.

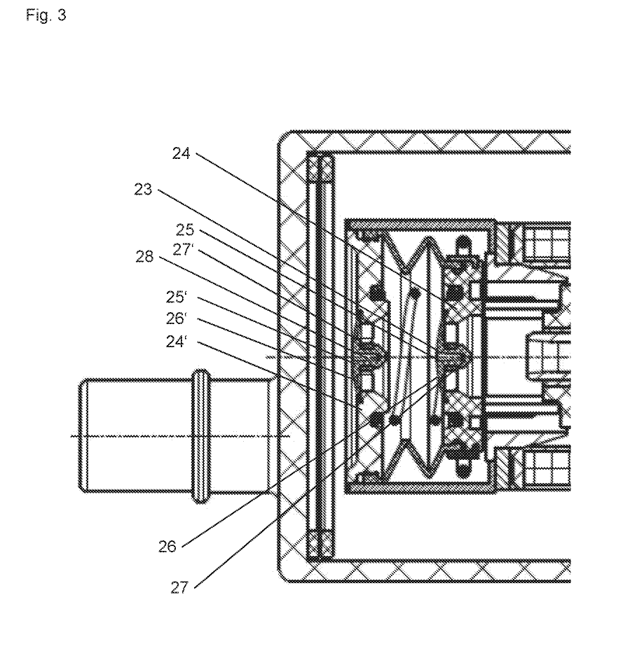

The pump assembly (2) according to FIG. 1 and FIG. 3 has an inlet valve (23) which is composed of a valve seat (24) and a valve body (25), wherein the valve body (25) has a highly elastic disc (26) and a centrally arranged holder (27).

The pump assembly (2) according to FIG. 3 furthermore has an outlet valve (28) which is composed of a valve seat (24′) and a valve body (25′), wherein the valve body (25′) has a highly elastic disc (26′) and a centrally arranged holder (27′).

The electrofluidic assembly (1) according to FIG. 2 contains a pressure sensor (30) and a temperature sensor (31) which are both connected to the outlet (13) of the assembly (1).

### LIST OF REFERENCE NUMBERS

1. Assembly
2. Pump assembly
3. Valve
4. Electromagnet
5. Bearing rod
6. Displacement apparatus
7. Solenoid armature
8. Closing body
9. Solenoid armature
11. Inlet
12. Magnetic coil
13. Outlet
14. Restoring spring
20. Bellows
21. Cylinder
22. Piston
23. Inlet valve
24. Valve seat
25. Valve body
26. Disc
27. Holder
28. Outlet valve
30. Pressure sensor
31. Temperature sensor
32. Tank
33. Electric control unit

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrofluidic assembly, comprising:
at least one electrofluidic pump assembly;
an electrofluidic valve;
wherein both the pump assembly and the valve are activated by in each case one electromagnet;
wherein the pump assembly and the valve are arranged on an identical central line and use a bearing rod jointly for movable bearing of a first solenoid armature which activates a displacement apparatus of the pump assembly on one hand and a second solenoid armature of the valve which activates a group of closing bodies on the other hand.

2. The electrofluidic assembly according to claim 1, wherein the bearing rod is formed as a tube which fluidically connects the displacement apparatus of the pump assembly to one of the fluidic ports, inlet or outlet, of the assembly.

3. The electrofluidic assembly according to claim 1, wherein in a deenergized state of the electromagnet which activates the valve, the valve fluidically connects an inlet of the assembly to an outlet of the assembly while bypassing the pump assembly, wherein the stated connection is closed in an energized state of the electromagnet.

4. The electrofluidic assembly according to claim 1, wherein in an energized state of the electromagnet which activates the valve, the valve fluidically connects an inlet of the assembly to an outlet of the assembly while bypassing the pump assembly, wherein the stated connection is closed in a deenergized state of the electromagnet.

5. The electrofluidic assembly according to claim 1, wherein the pump assembly has a bellows which is directly or indirectly activated linearly by the electromagnet and which acts as a fluidic displacement apparatus.

6. The electrofluidic assembly according to claim 1, wherein the pump assembly has a fluidic displacement apparatus which is composed at least of a cylinder and a piston.

7. The electrofluidic assembly according to claim 1, wherein the pump assembly has an inlet valve which is composed of a valve seat and a valve body, wherein the valve body has a highly elastic disc and a centrally arranged holder.

8. The electrofluidic assembly according to claim 1, wherein the pump assembly has an outlet valve which is composed of a valve seat and a valve body, wherein the valve body has a highly elastic disc and a centrally arranged holder.

9. The electrofluidic assembly according to claim 1, wherein the electrofluidic assembly includes a pressure sensor which is connected to an outlet of the assembly.

10. The electrofluidic assembly according to claim 1, wherein the electrofluidic assembly includes a temperature sensor which is connected to an outlet of the assembly.

11. A method for operating an electrofluidic assembly, which contains at least one electrofluidic pump assembly and an electrofluidic valve, wherein both the pump assembly and the valve are activated by an electromagnet or by in each case one electromagnet, the method comprising:
an electric control unit connected to the electrofluidic assembly actuates the electromagnets in such a manner that,
a fluidic pressure difference is built up at an outlet in that, in the case of a closed valve, the electromagnet of the pump assembly is energized in a clocked manner, wherein a solenoid armature correspondingly moves a displacement apparatus and wherein fluid is conveyed and in this case a gas pressure in a connected tank is increased or reduced;
the clocked energization of the electromagnet of the pump assembly is terminated and the valve is held closed by an energization of its electromagnet;
a pressure profile in a connected tank is measured in that a pressure sensor connected to the outlet or to a supply line to the tank transmits the profile of the pressure in the tank to the electric control unit, wherein the profile of the pressure is recorded in the electric control unit;
after a defined time Tv, measurement and recording of a second pressure profile are carried out;
the two pressure profiles are compared with one another and the imperviousness of the tank is concluded from the difference between the two pressure profiles; and
the pressure in the tank is reduced, the valve is opened in that the associated electromagnet is deenergized.

12. The method for operating an electrofluidic assembly according to claim 11, wherein during each measurement and recording of the pressure in the tank, the temperature of the fluid at the outlet or in the supply line to the tank is also measured and recorded by a temperature sensor, wherein then temperature profiles are also used with the aid of the ideal gas law to calculate a corrected profile of the pressure profiles during comparison of the pressure profiles.

13. The method for operating an electrofluidic assembly according to claim 11, wherein the electric control unit monitors the electrofluidic assembly in terms of its proper function in that both the profile of the energization of the electromagnet of the pump assembly and the profile of the pressure measured by the pressure sensor are recorded by the electric control unit and, by means of a comparison of the stated profiles including setpoint profiles stored in table form, malfunctions of the pump assembly or of the valve are discovered and reported to at least one superordinate electric control unit.

14. The method for operating an electrofluidic assembly according to claim 11, wherein after a start of operation at a temperature below a defined threshold temperature TG, the electric control unit actuates at least one of the electromagnets with electric pulses of a frequency greater than a defined threshold frequency fG until the temperature measured with the temperature sensor in the assembly exceeds threshold temperature TG.
